(19) United States
(12) Patent Application Publication
(10) Pub. No.: US 2018/0126758 A1
(43) Pub. Date: May 10, 2018

(54) METHOD AND SYSTEM TO DETECT A TRANSVERSAL MOVEMENT BETWEEN A PRINTER AND A RECORDING MEDIUM

(71) Applicant: Océ Holding B.V., Venlo (NL)

(72) Inventors: Marko Mihailovic, Muenchen (DE); Claus Schneider, Eching (DE); Philippe Koerner, Forstinning (DE); Ulrich Stoeckle, Muenchen (DE)

(73) Assignee: Océ Holding B.V., Venlo (NL)

(21) Appl. No.: 15/797,400

(22) Filed: Oct. 30, 2017

(30) Foreign Application Priority Data
Oct. 31, 2016 (DE) 10 2016 120752.7

(51) Int. Cl. B41J 25/00; B41J 2/045

(52) U.S. Cl. CPC B41J 25/001; B41J 2/04586; B41J 2/04508

(57) ABSTRACT

In a method for an inkjet printing system, substantially parallel lines are printed in the transport direction with nozzles at different longitudinal positions along the transport direction of the recording medium. Based on the variations of the transversal distance of corresponding image points of the substantially parallel lines, the transversal movement of the recording medium may be detected and a dimension of the transversal movement may be determined.

### CROSS REFERENCE TO RELATED APPLICATIONS

This patent application claims priority to German Patent Application No. 10 2016 120752.7, filed Oct. 31, 2016, which is incorporated herein by reference in its entirety.

### BACKGROUND

The present disclosure related to methods and systems for detecting a transversal movement of a recording medium in inkjet printing systems.

Ink printing systems may be used for printing to a recording medium (e.g. paper). An inkjet printing system may include one or more print bars having respectively one or more print heads. Each print bar may thereby be used for the printing of a specific color. The recording medium may be directed in a transport direction past the one or more print bars in order to print a print image onto the recording medium (e.g. paper) row by row. Upon transport of the recording medium, a lateral movement may also occur. What is to be understood by a lateral movement is a movement of the recording medium transversal to its transport direction.

One possibility for measuring the lateral movement of a recording medium is the use of an edge sensor (an image sensor, for example) in order to detect an edge of the recording medium. However, a lateral movement of the edge of the recording medium may thereby be caused not only by a lateral movement of the recording medium but also by the roughness of the edge itself. The precision of the measurement of a lateral movement of a recording medium by means of an edge sensor is thus limited.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 illustrates a block diagram of a movement detector to detect a lateral relative movement between the nozzles of an inkjet printing system and a recording medium according to an exemplary embodiment of the present disclosure;

FIG. 2 illustrates a block diagram of an inkjet printing system according to an exemplary embodiment of the present disclosure;

FIGS. 3a-d illustrate examples of printed line print images according to exemplary embodiments of the present disclosure;

FIGS. 4a and 4b illustrate examples of curves of the transversal distance of a measurement line from a reference line according to an exemplary embodiments of the present disclosure; and

FIG. 5 illustrates a flowchart of a method for determining a lateral relative movement between nozzles of an inkjet printing system and a recording medium according to an exemplary embodiment of the present disclosure.

The exemplary embodiments of the present disclosure will be described with reference to the accompanying drawings.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure.

The present disclosure it directed to systems and methods to reliably detect the lateral relative movement between the nozzles of an inkjet printing system and a recording medium, and of precisely determining the dimension of the lateral movement.

According to one aspect, a method is described for detecting and/or determining a transversal movement of a printer (also referred to as a printing unit) of an inkjet printing system relative to a recording medium. The printing system may be configured to move the printer and the recording medium relative to one another in a transport direction. The printer has a first nozzle at a first longitudinal position for printing image points of a first column of a print image, and a second nozzle at a second longitudinal position for printing image points of a second column of the print image, wherein the first longitudinal position and the second longitudinal position are offset from one another in the transport direction. The first column and the second column thereby travel in the transport direction, and the rows of a sequence of rows of the print image thereby travel transversal to the transport direction.

In an exemplary embodiment, the method includes the printing of a reference sequence of image points for the sequence of rows along the first column with the first nozzle, and the printing of a measurement sequence of image points for the sequence of rows along the second column with the second nozzle. Moreover, the method can include the acquisition of image data with regard to the reference sequence and the measurement sequence. Furthermore, the method can include the detection and/or determination of a transversal movement of the printer relative to the recording medium on the basis of the image data, said transversal movement taking place transversal to the transport direction.

One or more exemplary embodiments are directed to the precise and efficient determination of a lateral relative movement between nozzles of an inkjet printing system and a recording medium. A device, such as a movement detector, can be configured to detect a transversal movement is thereby described that is configured to execute the method described in this document.

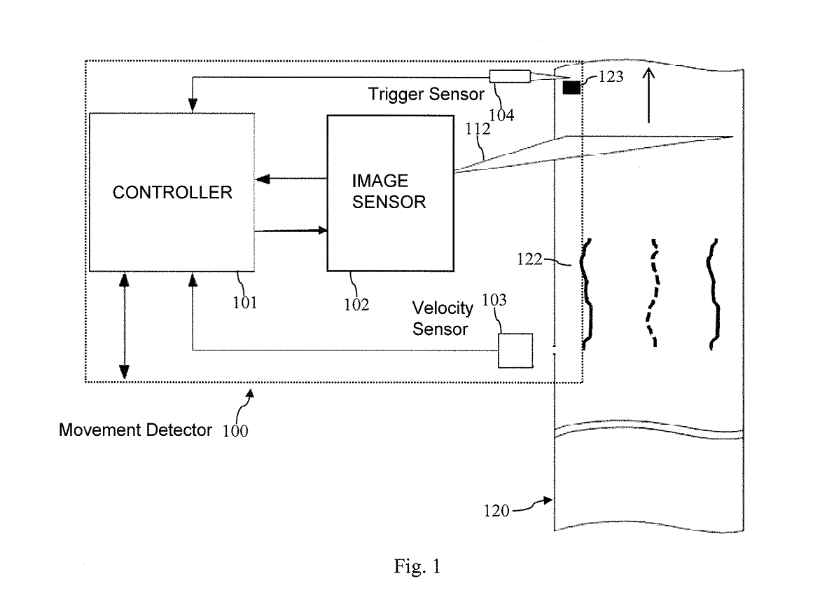

FIG. 1 shows a block diagram of an example of a movement detector 100 configured to detect a lateral movement of the recording medium 120 in a printing system 200 according to an exemplary embodiment. In particular, FIG. 1 shows a recording medium 120 having a line print image 122 that includes two or more lines in the transport direction. The recording medium 120 moves in the transport direction characterized by the arrow. In an exemplary embodiment, the movement detector 100 includes an image sensor 102 that is configured to visually acquire a portion of (or the entirety of) the surface of the recording medium 120. In an exemplary embodiment, the acquisition region 112 of the sensor 102 may depend on the width of a print image 122 on the recording medium 120. In particular, the entire width of a print image 122 may be acquired by the image sensor 102. Furthermore, in an exemplary embodiment, the acquisition region 112 of the image sensor 102 is such that respectively at least one printed row of the print image 122 may be acquired. For this purpose, the image sensor 102 may include a camera, such as, for example, a row camera or an in-line scanner. The data acquired by the image sensor 102 is designated as image data in this document. The image data may be transmitted to a controller 101 of the movement detector 100. In an exemplary embodiment, the movement detector 100 includes processor circuitry that is configured to perform one or more functions and/or operations of the movement detector 100, including, for example, detecting a movement (e.g. lateral movement) of the recording medium 120.

In an exemplary embodiment, the controller 101 is configured to analyze the image data. The controller 101 can be configured to detect a lateral movement of the recording medium 120 relative to a print bar 202 of the printing system 20 based on the image data, and/or to determine a dimension of said lateral movement. In an exemplary embodiment, the controller 101 may be configured to induce the image sensor 102 to acquire image data. In particular, the controller 101 may determine a point in time at which the image sensor 102 acquires a one-dimensional image (a row, for example) or a two-dimensional image of the surface of the recording medium 120. For example, it may thus be ensured that the acquired image data includes one or more rows of a printed line print image 122. In an exemplary embodiment, the controller 101 includes processor circuitry that is configured to perform one or more functions and/or operations of the controller 101, including, for example, analyzing the image data and/or detecting a lateral movement.

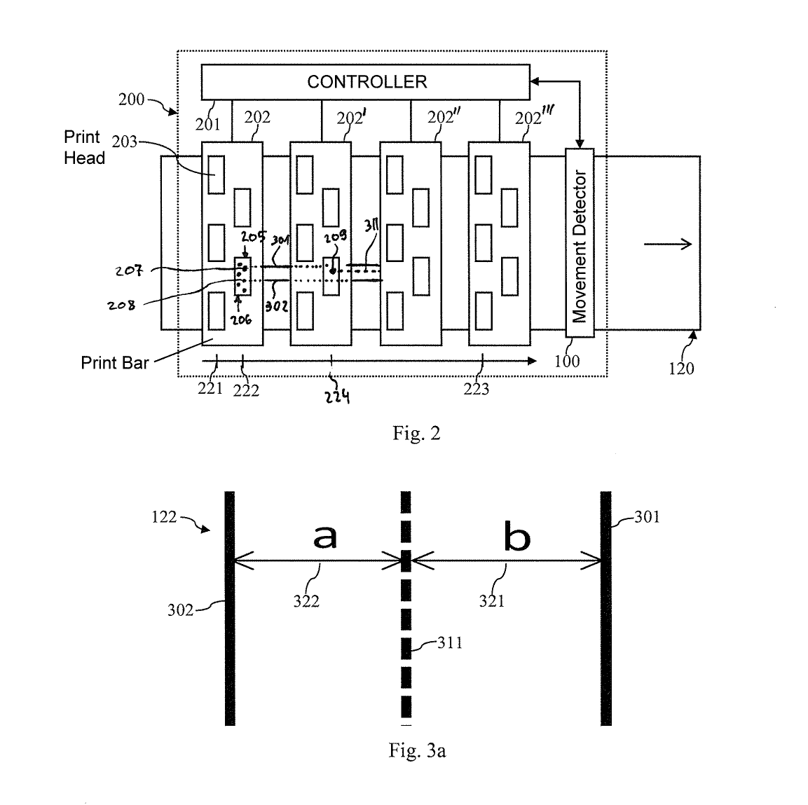

In an exemplary embodiment, the movement detector 100 depicted in FIG. 1 can be configured to detect a trigger mark 123 on the recording medium 120 (for example a dark/light transition of the trigger mark 123 or a light/dark transition of the trigger mark 123) using a suitable trigger sensor 104. In this example, the trigger sensor 104 may be configured to generate trigger data with regard to (e.g. based on) a trigger mark 123 on the recording medium 120. In an exemplary embodiment, the trigger sensor 104 includes processor circuitry that is configured to perform one or more functions and/or operations of the trigger sensor 104, including, for example, detect a trigger mark 123 and generate trigger data corresponding to the detected trigger mark 123. In an exemplary embodiment, the trigger mark 123 may have been printed on the recording medium 120 by the printing system 200 (FIG. 2). In an exemplary embodiment, the trigger mark 123 may have a predefined temporal and/or spatial distance from a linear print image 122. The trigger data may be used to synchronize the recording of the image data by the image sensor 102 with the printing of a line print image 122.

In an exemplary embodiment, the movement detector 100 may include a velocity sensor 103 that is configured to acquire velocity data with regard to a transport velocity of the recording medium 120 (in the transport direction shown by the arrow). The velocity sensor 103 may, for example, include a frictional wheel that is driven by the movement of the recording medium 120. The controller 101 may determine and control a velocity of the recording of the individual image rows by the image sensor 102 on the basis of the velocity data. In an exemplary embodiment, the velocity sensor 103 includes processor circuitry that is configured to perform one or more functions and/or operations of the velocity sensor 103, including, for example, determine a transport velocity and generate corresponding velocity data.

In an exemplary embodiment, the image sensor 102 has a resolution transversal to the transport direction of the recording medium 120 that corresponds to at least the number K of nozzles of a print bar 202 transversal to the transport direction of the recording medium 120. The resolution of the image sensor 102 transversal to the transport direction of the recording medium 120 may also be lower than the number of nozzles of a print head arrangement 202 transversal to the transport direction of the recording medium 120. Furthermore, in an exemplary embodiment, the image sensor 102 is configured to record the surface of the recording medium 120 in the transport direction with a scanning rate that corresponds to at least the resolution of a print image 122 in the transport direction of the recording medium 120. The image sensor 102 may also be configured to record the surface of the recording medium 120 in the transport direction with a scanning rate that is lower than the resolution of the print image 122 in the transport direction of said recording medium 120.

FIG. 2 shows a block diagram of an inkjet printing system 200 according to an exemplary embodiment of the present disclosure. In an exemplary embodiment, the printing system 200 depicted in FIG. 2 is designed for a continuous printing, meaning for printing on a “continuous” or web-shaped recording medium 120 (also designated as a “continuous feed”), but is not limited thereto. In this example, the recording medium 120 can be taken off from a roll (the take-off) and then supplied to the print group of the printing system 200. Via the print group, a print image is applied onto the recording medium 120 and the printed recording medium 120 is taken up again on an additional roll (the take-up), possibly after fixing/drying of the print image. Alternatively, the printed recording medium 120 may be cut into sheets or pages by a cutter. In FIG. 2, the transport direction of the recording medium 120 is represented by an arrow. The discussion of the various embodiments of the present disclosure are also applicable to a printing system for printing to sheet-shaped or page-shaped recording media 120, or other types of printing systems as would be understood by one of ordinary skill in the relevant arts.

In an exemplary embodiment, the print group of the printing system 200 includes four print bars 202, but is not limited thereto. The different print bars 202 may be used for printing with inks of different color (for example black, cyan, magenta and/or yellow). The print group may include one or more additional print bars 202 for printing with additional colors. In other aspects, the printing system 200 includes fewer than four print bars 202.

In an exemplary embodiment, each print head 203 includes one or more (e.g. multiple) nozzles, wherein each nozzle is configured to fire or eject ink droplets onto the recording medium 120. For example, a print head 203 may include, for example, 2558 effectively utilized nozzles that are arranged along one or more rows transversal to the transport direction of the recording medium 120. The nozzles in the individual rows 205 and 206 may be arranged offset from one another. A row on the recording medium 120 may respectively be printed transversal to the transport direction by means of the nozzles of a print head 203. An increased image point resolution may be provided via the use of L rows having (transversally offset) nozzles (L>1, for example L=32). In total, for example, K=12790 droplets may thus be fired by a print bar 202, depicted in FIG. 2, along a row onto the recording medium 120 (for example for a print width of approximately 54 cm at 600 dpi (dots per inch)).

In an exemplary embodiment, the printing system 200 includes a controller 201 (for example an activation hardware and/or control circuit) that is configured to activate the actuators of the individual nozzles of the individual print heads 203 in order to apply a print image onto the recording medium 120 depending on print data.

In an exemplary embodiment, the printing system 200 includes at least one print bar 202 having K nozzles that may be activated with a specific activation frequency in order to print a line (transversal to the transport direction of the recording medium 120) with K pixels or K columns onto the recording medium 120. In the presented example, the nozzles are immovable or installed fixed in the printing system 200, and the recording medium 120 is directed past the stationary nozzles with a defined transport velocity. A specific nozzle thus prints a corresponding specific column 301 or 302 (in the transport direction) onto the recording medium 120 (in a one-to-one association). A maximum of one ink ejection thus takes place via a specific nozzle per row of the print image.

In an exemplary embodiment, as depicted in FIG. 2, the nozzles of a printing system 200 may be arranged at different longitudinal positions 221, 222, 223, 224 along the transport direction. In particular, different print heads 203 of a print bar 202 may be arranged at different longitudinal positions 221, 222. For example, the print bars 202 depicted in FIG. 2 include two rows of print heads 203, wherein a second row of print heads 203 is arranged after a first row of print heads 203 in the transport direction. As a result of this, the nozzles of the print heads 203 of the second row are arranged at a second longitudinal position 222, and the nozzles of the print heads 203 of the first row are arranged at a first longitudinal position 221. The longitudinal distance between the first and second longitudinal position 221, 222 may be 20-25 cm, for example. Furthermore, the nozzles of the print heads 203 of different print bars 202 are arranged at different longitudinal positions 221, 223 or 224. Moreover, within a print head 203, nozzles may also be arranged in different nozzle rows, and thus at different longitudinal positions.

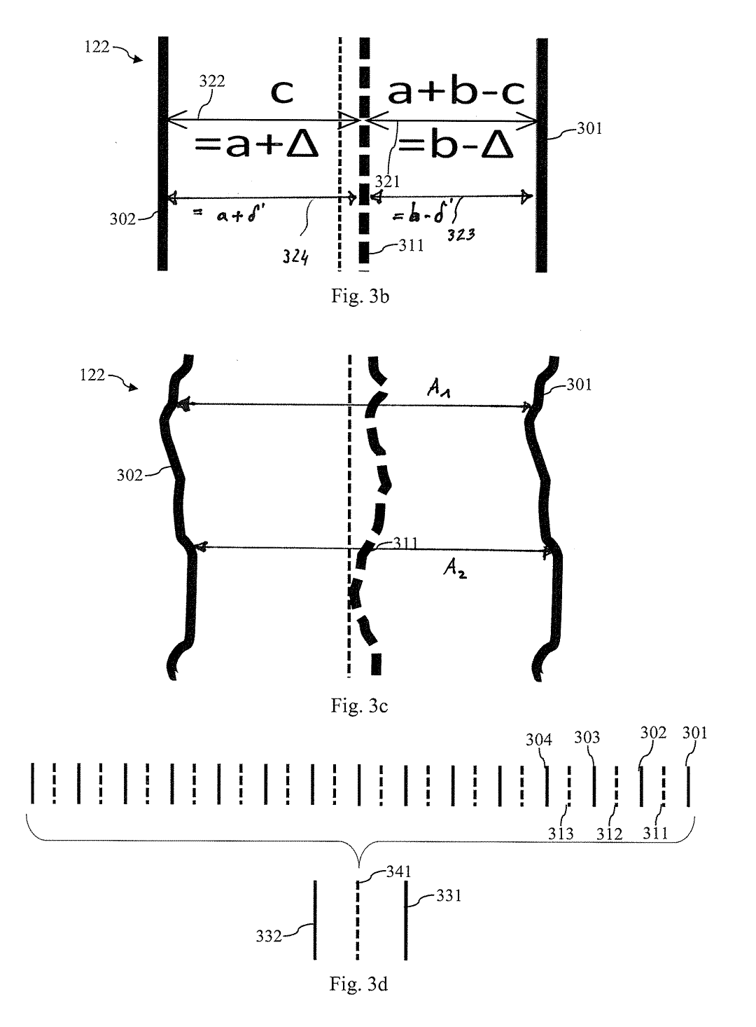

FIG. 3a shows an example of a line print image 122 according to an exemplary embodiment. In an exemplary embodiment, the line print image 122 includes a first reference line 301 (also generally referred to in the present disclosure as a reference sequence of image points) and a second reference line 302 that has been printed by a first nozzle 207 and a third nozzle 208. The references lines 301, 302 travel (extend) in the transport direction (i.e. along a first and a third column). The first nozzle 207 and the third nozzle 208 are thereby located at the same longitudinal position 222 (which may be designated as a reference position). For example, the first nozzle 207 and the third nozzle 208 may be arranged in the same print head 203, as depicted in FIG. 2. As an alternative to this, the two nozzles 207 and 208 may be arranged in two different print heads 204 that are located in the first row of print heads 203 of a print bar 202. Furthermore, in an exemplary embodiment, the line print image 122 includes a measurement line 311 (also generally designated as a measurement sequence of image points in the present disclosure) that has been printed by a second nozzle 209. The second nozzle 209 is thereby arranged at a longitudinal position 224 that differs from the reference position 222. The longitudinal position 224 of the second nozzle 204 may be designated as a measurement position 224. The second nozzle 209 may be arranged in a different print head 203 and/or in a different nozzle row than the first and third nozzle, but still within a print bar 202. The second nozzle 209 may thus be arranged in the longitudinal position 221, or vice versa.

In an aligned (e.g. ideally aligned) printing system 200, the second nozzle 209 has a first transversal distance b 321 (transversal to the transport direction) from the first nozzle 207, and a second transversal distance a 322 from the third nozzle 208. As a result of this, in an ideally aligned printing system 200 the measurement line 311 has the first transversal distance b 321 from the first reference line 301 and the second transversal distance a 322 to the second reference line 302.

In an aligned (e.g. ideally aligned) printing system, the corresponding image point of a specific row of the measurement line 311 is printed at a different point in time (e.g. after) than the corresponding image points of this specific row of the reference lines 301, 302. A lateral movement of the recording medium 120 between the longitudinal position 222 of the first nozzle 207 and third nozzle 208 up to the longitudinal position 224 of the second nozzle 209 leads to the situation that the transversal distances 321, 322 of the image points of a row vary depending on the lateral movement of the recording medium 120. In this example, a first transversal distance 321 b−Δ and a second transversal distance 322 a+Δ thus result, where the (variable) deviation Δ now depends on (corresponds to) the lateral movement of the recording medium 120.

FIG. 3c shows examples of curves of the measurement line 311 and of the reference lines 301, 302. As is clear from FIG. 3c, the transversal distances 321, 322 change from row to row (or with time). These changes of the transversal distances 321, 322 are based (at least in part) on lateral movements of the recording medium 120. The changes of the transversal distances 321, 322 are thereby shown intensified in FIG. 3c since the width of a line 301, 302, 311 is typically in the range of, for example, 50 μm, and the dimension of lateral movements is typically, for example, at most 10-15 μm. It is to be maintained that the distance A₁ and the distance A₂ between the reference lines 301 and 302 remains unchanged, since these reference lines 301 and 302 are printed simultaneously. A₁=A₂=a+b therefore applies. The printed curve of the reference line 301 is therefore identical to the curve of the reference line 302.

In practice, as illustrated in FIG. 3b, however, a constant deviation δ′ may result due to displacements upon installation of the print heads 203, such that b−δ′ results as a first transversal distance 323 between the first reference line 301 and the measurement line 311, and a+δ′ results as a second transversal distance 324 between the second reference line 302 and the measurement line 311. For example, the first nozzle 207 and the third nozzle 208 may be arranged in a print head 203. The constant deviation δ′ in this instance shows the dimension of a displacement upon installation of the print head 203. In FIG. 3b, the deviation δ′ and Δ are coincidentally of equal magnitude. A torsion of a print head may, for example, be detected if the total distance a+b between the printed reference lines 301 and 302 is smaller than the distance between the first nozzle 207 and the second nozzle 208 at the print head.

Moreover, the individual nozzles may have random changes to the ejection direction of ink (what is known as a jet angle error), such that the fluctuating lines 301, 302, 311 from FIG. 3c may be produced at least in part by random changes of the ejection direction of the individual nozzles. In order to reduce the influence of the random changes of the ejection direction, a plurality of reference lines 301, 302, 303, 304 and a plurality of measurement lines 311, 312, 313 (arranged between the reference lines 301, 302, 303, 304) may be printed (see FIG. 3d). From these, averaged or smoothed reference lines 331, 332 and an averaged or smoothed measurement line 341 may then be determined. In particular, different line groups with two respective reference lines 301, 302 and a measurement line 311 situated between them may be printed, acquired and averaged (for example 80 groups for a print head 203) in order to determine a line group of averaged reference lines 331, 332 and an averaged measurement line 341 situated between them.

A curve of the deviation Δ of the measurement line 311 from an ideal position may thus be determined on the basis of the reference lines 301, 302 (in particular on the basis of the smoothed reference lines 331, 332) and on the basis of the measurement line 311 (in particular on the basis of the smoothed measurement line 341). The deviation Δ may therefore be a systematic deviation δ that, for example, is caused by a displacement of the print head 203 and/or by a systematic deviation δ of the ejection direction of a nozzle. The systematic deviation δ may be considered to be a constant component of the curve of the deviation Δ. A remaining alternating component of the curve of deviation Δ then results.

In an exemplary embodiment, random fluctuations of the ejection direction (what is known as a jet angle error) may typically be remedied via the averaging or smoothing described above. As a result of this, the alternating component of the curve of the deviation Δ indicates the lateral movement of the recording medium (given use of the smoothed lines 331, 332, 341).

In an exemplary embodiment, as shown in FIG. 1, a line print image 122 may be acquired (e.g. per row) by an image sensor 102. For each row (i.e. at every point in time), the transversal distances 321, 322 of the measurement line 311 may thereby be determined relative to one or two reference lines 301, 302 and the deviation Δ. The deviation Δ may thereby be determined with increased precision given consideration of two reference lines 301, 302.

In an exemplary embodiment, the determination of the transversal distances 321, 322 and of the deviation Δ may take place (per row) for a plurality of line groups of reference lines 301, 302 and measurement lines 311 to determine averaged values for the transversal distances 321, 322 and for the deviation Δ. A sequence of (averaged) deviations Δ, meaning a time curve or row-dependent curve of the (averaged) deviation Δ, may thus be determined for a sequence of rows.

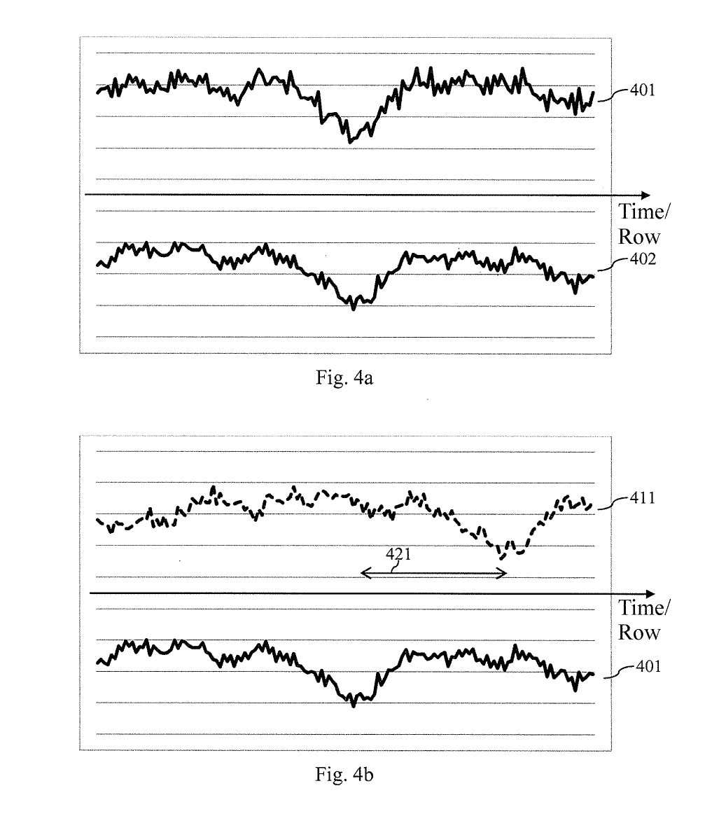

FIG. 4a shows examples of time curves 401, 402 of the deviation Δ for two print heads 203 according to an exemplary embodiment that are arranged in the same print head row of a print bar 202. In this example, nozzles in different nozzle rows of a print head 203 were used for determination of the curves 401, 402 in order to print reference lines 301, 302 and measurement lines 311, and in order to determine the deviation Δ. The two time curves 401, 402 travel synchronously with one another to the greatest possible extent. FIG. 4a thus shows that the time curves 401, 402 of the deviation Δ that have been determined for different print heads 203 of the same print head row reflect the same lateral movement of the recording medium 120.

On the other hand, FIG. 4b shows time curves 401, 411 of the deviation Δ for two print heads 203 that are arranged in different print head rows of a print bar 202. The two time curves 401, 411 have a time offset 421 from one another, wherein the time offset 421 corresponds to the longitudinal distance (in the transport direction) between the two print heads 203. Due to the longitudinal distance of the two print heads 203, a lateral movement of the recording medium 120 affects the print image 122 printed by a print head 203 of the second print head row only with the time offset 421. FIG. 4b thus shows that the time curves 401, 411 of the deviation Δ that were determined for different print heads 203 in different print head rows reflect the same lateral movement of the recording medium 120.

From FIGS. 4a and 4b it is thus clear that the time curve 401, 402, 411 of the deviation Δ is a reliable and precise indicator of the lateral movement of a recording medium 120. The amplitude of the time curve 401, 402, 411 of the deviation Δ may be analyzed in order to determine whether the lateral movement of the recording medium 120 reaches or exceeds a reliable threshold. Measures may then be introduced in order to reduce the lateral movement of the recording medium 120. The print quality of a printing system 200 may thus be increased.

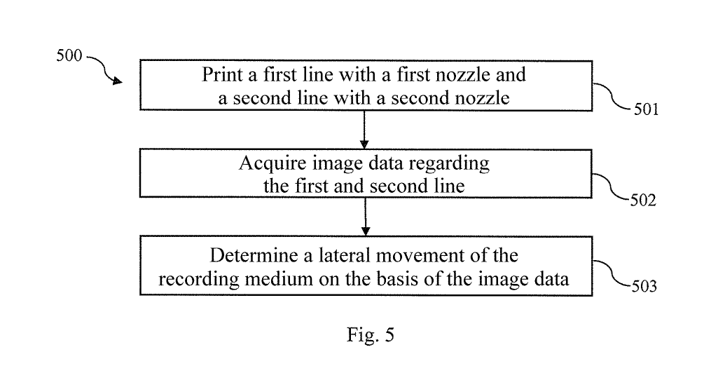

FIG. 5 shows flowchart of a method 500 for detecting the transversal movement between a printer (also referred to as a printing unit) 202, 203 of an inkjet printing system 200 and a recording medium 120 according to an exemplary embodiment of the present disclosure. The printer 202, 203 may correspond to the entire print group of the printing system 200 (possibly with multiple print bars 202), to a print bar 202 having one or more print heads 203, and/or to a print head 203 having one or more nozzles.

In an exemplary embodiment, the printing system 200 from FIG. 2 is configured to move the printer 202, 203 and the recording medium 120 relative to one another in a transport direction. The printer 202, 203 is thereby installed in a fixed manner, and the recording medium 120 is directed in the transport direction past the stationary printer 202, 203. Sequential rows of a print image 122 may be printed on the recording medium 120 via the relative movement between printer 202, 203 and recording medium 120. The individual rows of a sequence of rows of the print image 122 thereby travel transversal to the transport direction. On the other hand, the different columns of the print image 122 travel along the transport direction.

In an exemplary embodiment, the printer, together with print bar 202 and print head 203, include a first nozzle at a first longitudinal position 221 for printing of image points of a first column of the print image 122 and a second nozzle at a second longitudinal position 222 for printing of image points of a second column of the print image 122. The first longitudinal position 221 and the second longitudinal position 222 are thereby offset from one another in the transport direction. The individual nozzles of a printer 202, 203 are typically configured in order to print the image points of precisely one respective column of a print image 122. This means that there is typically a one-to-one relation between the nozzles of the printer 202, 203 and the columns of the print image 122.

For example, the printer may include a print group having a first print bar for printing with a first ink and a second print bar for printing with a second ink. The first and second print bar are thereby arranged offset from one another in the transport direction. The first nozzle may be arranged in the first print bar, and the second nozzle may be arranged in the second print bar. The first longitudinal position 221 and the second longitudinal position 222 in this instance have a relatively high longitudinal distance (in the transport direction) relative to one another (for example of 50 cm, 1 m or more).

In an exemplary embodiment, the printer may include a print bar 202 for printing with a specific ink. The print bar 202 includes a first print head 203 in a first print head row and a second print head 203 in a second print head row of the print bar 202, wherein the first print head row and the second print head row are arranged offset from one another in the transport direction. The first nozzle may then be arranged in the first print head 203, and the second nozzle may be arranged in the second print head 203. The first longitudinal position 221 and the second longitudinal position 222 in this instance have an average longitudinal distance (in the transport direction) relative to one another (for example 15-30 cm).

In an exemplary embodiment, the printer may include a print head 203 for printing of at least a portion of the columns of the print image 122. The print head 203 may have multiple nozzle rows, for example a first nozzle row and a second nozzle row that are offset from one another in the transport direction. The first nozzle may then be arranged in the first nozzle row of the print head 203, and the second nozzle may then be arranged in the second nozzle row of the print head 203. The first longitudinal position 221 and the second longitudinal position 222 in this instance have a relatively small longitudinal distance (in the transport direction) relative to one another (for example 1-2 cm).

In an exemplary embodiment, the method 500 includes the printing 501 of a reference sequence 301 of image points for the sequence of rows along the first column with the first nozzle, and a measurement sequence 311 of image points for the sequence of rows along the second column with the second nozzle. In particular, a reference line 301 (via the first nozzle) and a measurement line 311 (via the second nozzle) may be printed on the recording medium 120 substantially parallel to one another in the transport direction. The reference sequences 301 and the measurement sequence 311 (or the reference line 301 and the measurement line 311) thereby have respectively one image point for each row of the sequence of rows.

The method 500 can additionally include the acquisition 502 of image data with regard to the reference sequence 301 and the measurement sequence of image points. For example, sequential image data with regard to the image points of the two sequences 301, 311 may be acquired with the line camera.

Further, the method 500 can also include the detection 503 of a transversal movement that has occurred transversal to the transport direction between the printer 202, 203 and the recording medium 120 on the basis of the image data. In particular, a transversal movement of the recording medium 120 may be detected relative to the (stationary) printer 202, 203.

Due to the different longitudinal positions 221, 222 of the first and second nozzle, the corresponding image points of a row from the reference sequence 301 and from the measurement sequence 311 are printed at different points in time. The time offset of the printing of the corresponding image points of a row thereby corresponds to the longitudinal distance between the first and second longitudinal position 221, 222. In the time period that lies between the printing of the corresponding image points, a transversal movement may occur between one or more of the printers 202, 203 and recording medium 120, and therefore a transversal offset of the printed, corresponding image points of a row may occur. The transversal offset of the printed image points may be detected on the basis of the image data, from which the transversal movement may then in turn be detected. The method 500 thus enables the transversal movement between printer 202, 203 and recording medium 120 to be determined efficiently and precisely.

A method 500 for an inkjet printing system 200 is thus described in which substantially parallel lines 301, 311 may be printed in the transport direction with nozzles at different longitudinal positions 221, 222 along said transport direction of the recording medium 120. The transversal movement of the recording medium 120 may be detected on the basis of variations of the transversal distance 321 from corresponding image points of lines of the substantially parallel lines 301, 311, and a dimension of the transversal movement may be determined.

In an exemplary embodiment, the detection 503 of a transversal movement may in particular include the determination, on the basis of the image data, of a sequence of transversal distances 321 between corresponding image points of the reference sequence 301 and of the measurement sequence 311 for the sequence of rows. In other words, a transversal distance 321 of the corresponding image points of the reference sequence 301 and of the measurement sequence 311 may be determined for each row of the sequence of rows. The transversal movement may then be detected on the basis of the sequence of transversal distances 321. In particular, the transversal movement may be detected on the basis of a variation or a modification of the transversal distances 321 within the sequence of transversal distances 321. For example, the transversal movement may be detected on the basis of the difference between a first transversal distance 321 in a first row and a second transversal distance 321 in a different, second row. The magnitude of the difference may thereby indicate the dimension of the transversal movement. The transversal movement may be reliably and precisely detected via consideration of the transversal movement of the transversal distance 321 between corresponding image points of the reference sequence 301 and of the measurement sequence 311 in different rows.

In an exemplary embodiment, the detection 503 of a transversal movement may include the determination, on the basis of the image data, of a reference transversal distance between corresponding image points of the reference sequence 301 and of the measurement sequence 311 for the sequence of rows. For example, for this the mean value of the transversal distances 321 may be determined from the sequence of transversal distances 321. The reference transversal distance may represent a reference value for the transversal distance. The reference value thereby typically depends on systematic deviations of the position from image points of a column, for example inaccuracies in the arrangement of the nozzles of the printer 202, 203 and/or deviations in the ink ejection direction of the nozzles of the printer 202, 203. Furthermore, the reference transversal distance may be considered as a “constant component” of the sequence of transversal distances 321.

In an exemplary embodiment, a sequence 401, 402, 411 of deviations of the transversal distance 321 from the reference transversal distance may then be determined on the basis of the image data. The sequence 401, 402, 411 of deviations may be considered as a “constant component” of the sequence of transversal distances 321. The transversal movement may then be detected on the basis of the sequence 401, 402, 411 of deviations. In particular, the transversal movement may correspond to the sequence 401, 402, 411 of deviations. A precise determination of the dimension of the transversal movement is thus enabled.

In an exemplary embodiment, the method 500 may include the comparison of a deviation of the sequence 401, 402, 411 of deviations with a deviation threshold. For example, a measure to reduce the transversal movement may be induced (for example the output of an error message) if it is detected that the deviation for a specific row is greater than the deviation threshold. The print quality of a printing system 200 may thus be increased.

In an exemplary embodiment, the printer 202, 203 may include a plurality of first nozzles at the first longitudinal position 221 and a plurality of second nozzles at the second longitudinal position 222. The method 500 may then include the printing of a plurality of reference sequences 301, 303 of image points having the plurality of first nozzles, and a plurality of measurement sequences 311, 313 of image points having the plurality of second nozzles. In particular, multiple reference lines 301, 303 and multiple measurement lines 311, 313 may be printed that travel substantially parallel to one another (and that respectively include an image point for each row of the sequence of rows). The image data may then indicate the plurality of reference sequences 301, 303 and the plurality of measurement sequences 311, 313. The transversal movement may thus be determined on the basis of a plurality of reference sequences 301, 303 and a plurality of measurement sequences 311, 313 that have been printed by different nozzles. Random deviations of the positions of the image points of a row (due to random variations of the ejection direction of the nozzles) may thus be compensated. The transversal movement may thus be determined with an increased precision.

A sequence of average transversal distances may be determined on the basis of the image data with regard to the plurality of reference sequences 301, 303 and the plurality of measurement sequences 311, 313. In particular, a plurality of sequences of transversal distances 321 between corresponding image points (in particular between corresponding image point pairs) of the plurality of reference sequences 301, 303 and the plurality of measurement sequences 311, 313 may be determined on the basis of the image data. A sequence of average transversal distances may be determined on the basis of the plurality of sequences of transversal distances 321 (for example for each row of the sequence of rows, via calculation of the mean values of the transversal distances 321 for the respective row). The transversal movement may then be detected with high precision on the basis of the sequence of mean transversal distances. In particular, a mean reference transversal distance may be determined on the basis of the sequence of mean transversal distances. A sequence 401, 402, 411 of deviations of the mean transversal distance 321 from the mean reference transversal distance may be determined as an indicator of the transversal movement.

In an exemplary embodiment, the printer 202, 203 may include a third nozzle at the first longitudinal position 221 for printing of image points of a third column of the print image 122, wherein the second column is arranged between the first and third column. The method 500 may then include the printing of a second reference sequence 302 of image points for the sequence of rows along the third column with the third nozzle. In particular, a second reference line 302 may be printed. The image data may then also indicate the second reference sequence 302 of image points. The transversal movement may then also be determined on the basis of the image data with regard to the second reference sequence 302. In particular, a sequence of second transversal distances 322 between corresponding image points of the measurement sequence 311 and the reference sequence 302 may be determined for the sequence of rows. The transversal movement may then also be detected on the basis of the sequence of second transversal distances 322. For example, the transversal movement may be determined on the basis of the (row by row) difference of the sequence of transversal distances 321 and the sequence of second distances 322.

Via the consideration of (simultaneously printed) reference sequences 301, 302 that frame a measurement sequence 311 (printed earlier or later), a systematic offset between the nozzles of a printer 202, 203 (for example due to a torsion of a print head 203) may be precisely detected and compensated. The dimension of a transversal movement may thus be determined with increased accuracy.

An inkjet printer may thereby include the device described above for the detection of a transversal movement and/or the method described above for the detection of a transversal movement.

### CONCLUSION

The aforementioned description of the specific embodiments will so fully reveal the general nature of the disclosure that others can, by applying knowledge within the skill of the art, readily modify and/or adapt for various applications such specific embodiments, without undue experimentation, and without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purposes of this discussion, “processor circuitry” can include one or more circuits, one or more processors, logic, or a combination thereof. For example, a circuit can include an analog circuit, a digital circuit, state machine logic, other structural electronic hardware, or a combination thereof. A processor can include a microprocessor, a digital signal processor (DSP), or other hardware processor. In one or more exemplary embodiments, the processor can include a memory, and the processor can be “hard-coded” with instructions to perform corresponding function(s) according to embodiments described herein. In these examples, the hard-coded instructions can be stored on the memory. Alternatively or additionally, the processor can access an internal and/or external memory to retrieve instructions stored in the internal and/or external memory, which when executed by the processor, perform the corresponding function(s) associated with the processor, and/or one or more functions and/or operations related to the operation of a component having the processor included therein.

In one or more of the exemplary embodiments described herein, the memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

### REFERENCE LIST

100 device to determine a transversal movement (e.g. movement detector)
101 controller of movement detector 100
102 image sensor
103 velocity sensor
104 trigger sensor
112 region acquired by the 102
120 recording medium
122 print image
123 trigger marking
200 printing system
201 controller of the printing system 200
202 print head arrangement, print bar
203 print head
221, 222, 223 longitudinal position
301, 302 reference sequence of image points (reference line)
311 measurement sequence of image points (measurement line)
321, 322 transversal distance
331, 332 averaged reference line
341 averaged measurement line
401, 402, 411 sequence or curve of the deviation
421 row offset
500 method to detect a transversal movement between nozzles of a printing system and a recording medium
501, 502, 503 method steps

What is claimed is:

1. A method to detect a transversal movement between a printer of an inkjet printing system and a recording medium, the printing system being configured to move the printer and the recording medium relative to one another in a transport direction, and including a first nozzle at a first longitudinal position to print image points of a first column of a print image and a second nozzle at a second longitudinal position to print image points of a second column of the print image, wherein the first longitudinal position and the second longitudinal position are offset from one another in the transport direction, the method comprising:
printing a reference sequence of image points on the recording medium for a sequence of rows along the first column with the first nozzle;
printing a measurement sequence of image points for the sequence of rows along a second row with the second nozzle;
acquiring image data based on the reference sequences and the measurement sequence; and
detecting a transversal movement, taking place transversal to the transport direction, between the printer and the recording medium based on the image data.

2. The method according to claim 1, wherein:
the detection of a transversal movement comprises determining, based on the image data, a sequence of transversal distances between corresponding image points of the reference sequence and of the measurement sequence for the sequence of rows; and
the transversal movement is detected based on the transversal distances.

3. The method according to claim 2, wherein the transversal movement is detected based on a variation of the sequence of transversal distances for the sequence of rows.

4. The method according to claim 2, wherein the detection of a transversal movement comprises:
determining, based on the image data, a reference transversal distance for the sequence of transversal distances;
determining, based on the image data, a sequence of deviations of the transversal distance from the reference transversal distance; and
detecting the transversal movement based on the sequence of deviations.

5. The method according to claim 4, wherein the detection of a transversal movement comprises comparing a deviation of the sequence of deviations with a deviation threshold.

6. The method according to claim 3, wherein the detection of a transversal movement comprises:
determining, based on the image data, a reference transversal distance for the sequence of transversal distances;
determining, based on the image data, a sequence of deviations of the transversal distance from the reference transversal distance; and
detecting the transversal movement based on the sequence of deviations.

7. The method according to claim 6, wherein the detection of a transversal movement comprises comparing a deviation of the sequence of deviations with a deviation threshold.

8. The method according to claim 2, wherein:
the printer comprises a plurality of first nozzles at the first longitudinal position and a plurality of second nozzles at the second longitudinal position;
the method comprises printing the plurality of reference sequences of image points with a plurality of first nozzles, and printing the plurality of measurement sequences of image points with the plurality of second nozzles; and
the image data is indicative of the plurality of reference sequences and the plurality of measurement sequences.

9. The method according to claim 8, wherein:
the detection of the transversal movement comprises determining, based on the image data, the plurality of sequences of transversal distances between corresponding image point pairs of the plurality of reference sequences and of the plurality of measurement sequences;
the detection of the transversal movement comprises determining a sequence of average transversal distances based on the plurality of sequences of transversal distances; and
the transversal movement is detected based on the sequence of average transversal distances.

10. The method according to claim 2, wherein:
the printer comprises a first nozzle at the first longitudinal position for printing of image points of a third column of the print image;
the second column is arranged between the first and third column;
the method further comprises printing, with the third nozzle, a second reference sequence of image points for the sequence of rows along the third column; and
the image data is indicative of the second reference sequence of image points.

11. The method according to claim 10, wherein:
the detection of the transversal movement comprises determining a sequence of second transversal distances between corresponding image points of the measurement sequence and of the second reference sequence for the sequence of rows; and
the transversal movement is also detected based on the sequence of second transversal distances.

12. The method according to claim 1, wherein the printer comprises one of:
(a) a print group having a first print bar to print with a first ink and a second print bar for printing with a second ink, the first and second print bar being arranged offset from one another in the transport direction; and the first nozzle being arranged in the first print bar, and the second nozzle is arranged in the second print bar;
(b) a print bar to print with a specific ink, the print bar including a first print head in a first print head row and a second print head in a second print head row of the print bar, the first print head row and the second print head row being arranged offset from one another in the transport direction, and the first nozzle being arranged in the first print head and the second nozzle is arranged in the second print head; and
(c) a print head to print at least a portion of the columns of the print image, the first nozzle being arranged in a first nozzle row of the print head, and the second nozzle is arranged in a second nozzle row of the print head; and the first nozzle row and the second nozzle row being offset from one another in the transport direction.

13. A non-transitory computer-readable storage medium with an executable program stored thereon, wherein, when executed, the program instructs a processor to perform the method of claim 1.

14. An inkjet printing system comprising:
a printer configured to print to a recording medium, the printer and the recording medium being movable relative to one another in a transport direction, wherein:
the printer includes a first nozzle at a first longitudinal position that is configured to print image points of a first column of a print image and a second nozzle at a second longitudinal position that is configured to print image points of a second column of the print image, the first longitudinal position and the second longitudinal position being offset from one another in the transport direction; and
the printing to the recording medium includes printing a reference sequence of image points on the recording medium for a sequence of rows along the first column with the first nozzle, and printing a measurement sequence of image points for the sequence of rows along a second row with the second nozzle; and
a movement detector configured to:
acquire image data based on the reference sequences and the measurement sequence; and
detect a transversal movement, taking place transversal to the transport direction, between the printer and the recording medium based on the image data.

15. The inkjet printing system according to claim 14, wherein the printer comprises one of:
(a) a print group having a first print bar to print with a first ink and a second print bar for printing with a second ink, the first and second print bar being arranged offset from one another in the transport direction; and the first nozzle being arranged in the first print bar, and the second nozzle is arranged in the second print bar;
(b) a print bar to print with a specific ink, the print bar including a first print head in a first print head row and a second print head in a second print head row of the print bar, the first print head row and the second print head row being arranged offset from one another in the transport direction, and the first nozzle being arranged in the first print head and the second nozzle is arranged in the second print head; and
(c) a print head to print at least a portion of the columns of the print image, the first nozzle being arranged in a first nozzle row of the print head, and the second nozzle is arranged in a second nozzle row of the print head; and the first nozzle row and the second nozzle row being offset from one another in the transport direction.

16. The inkjet printing system according to claim 14, wherein:
the detection of the transversal movement comprises determining, based on the image data, a sequence of transversal distances between corresponding image points of the reference sequence and of the measurement sequence for the sequence of rows; and
the transversal movement is detected based on the transversal distances.

17. The inkjet printing system according to claim 16, wherein the transversal movement is detected based on a variation of the sequence of transversal distances for the sequence of rows.
